(19) United States
(12) Patent Application Publication
(10) Pub. No.: US 2021/0171865 A1
(43) Pub. Date: Jun. 10, 2021

(54) Detergent Composition

(71) Applicant: LONZA, LLC, Morristown, NJ (US)

(72) Inventor: Elias Pambou, Blackley, Manchester (GB)

(21) Appl. No.: 17/251,912

(22) PCT Filed: Jul. 19, 2019
(86) PCT No.: PCT/US19/42577

§ 371 Date: Dec. 14, 2020

Related U.S. Application Data
(60) Provisional application No. 62/700,425, filed on Jul. 19, 2018.

(51) Int. Cl. C11D 1/831; C11D 3/20; C11D 3/37; C11D 3/386; C11D 3/43; C11D 17/04; C11D 11/00

(52) U.S. Cl. CPC C11D 1/831; C11D 3/2044; C11D 3/2068; C11D 3/3707; C11D 1/22; C11D 3/43; C11D 17/043; C11D 11/0023; C11D 11/0017; C11D 3/386

(57) ABSTRACT

Described is a detergent composition, having a surfactant(s) and a carrier; whereby the composition is useful for useful for hygiene or consumer/home care products such as a dishwashing liquid, laundry detergent, hand washing liquid, or other household detergent-based compositions.

### FIELD OF INVENTION

The disclosure relates to a detergent composition useful for hygiene, consumer or home care products such as dishwashing, laundry, dish hand-washing liquid and other household detergent-based compositions.

### BACKGROUND OF THE INVENTION

Currently, there is a need in the art to provide a detergent composition for end-user formulation of consumer/home care, or hygiene products containing low or high surfactant levels; whereby the composition provides superior detergency (cleaning) in comparison to commercially available products, requiring less energy (heating), less water and provides quicker wash cycles during use, without the penalty of a very high energy usage. Further, there is a need in the art for detergent compositions which can be prepared from naturally derived ingredients or “green” ingredients, in particular, naturally derived nonionic surfactants which can provide a natural based detergent composition.

There is a need in the consumer care sector for low-energy washes which provides the desired detergency action and which output a smaller amount of heat and mechanical energy, saving the consumer costs and decreasing energy consumption. Through a focus on surfactant development based upon natural, plant-derived materials, hygiene, or consumer/home care detergent-based products upon the addition of polyglyceryl esters offer improved cleansing efficacy in comparison to current commercially available detergents-based products. Additionally the use of polyglyceryl fatty esters as an alternative surfactant to the use of non-ionic surfactants may assist in the wash time reduction, lower energy usage, and less water wastage ultimately leading to a more environmentally friendly and cost friendly product. Additionally, the use of natural sources of polyglyceryl fatty esters as one of the main components in such compositions, results in a more bio-based detergent composition for end-user products, in comparison to current bio-based commercial products. Furthermore, the addition of polyglyceryl fatty esters overcomes the current issues of detergent compositions demanding high surfactant levels, where such detergent-based compositions are currently impossible in fluid form. Therefore the addition of one or more polyglyceryl fatty esters helps overcome these issues, allowing for fluid, gel forms of detergent compositions having high surfactant levels for improved detergency.

The present disclosure provides an answer to that need of having a laundry detergent composition containing one or more surfactant(s), whereby at least one surfactant is a polyglyceryl fatty ester compound of natural origin.

### SUMMARY OF THE DISCLOSURE

In one aspect, the provided is a detergent composition containing a surfactant and a carrier for the surfactant, where the surfactant is a polyglyceryl fatty acid ester or a mixture of polyglyceryl fatty acid esters. The detergent composition may be further diluted, dissolved or dispersed in various end-user products.

In one embodiment, one or more of the polyglyceryl fatty ester is derived from (a) a polyglycerol component built up from 2 to 18 molecules of glycerol, based on an average, and (b) a fatty acid selected from the group consisting of caprylic acid, capric acid, lauric acid, myristic acid, palmitic acid, stearic acid, arachidic acid, behenic acid, lignoceric acid, cerotic acid, oleic acid, decaoleic acid, ricinoleic acid, or mixtures thereof.

In one particular embodiment, the polyglyceryl fatty ester is a polyglyceryl-10 decaoleate; polyglyceryl-3 monostearate; polyglyceryl-6 distearate, polyglyceryl-10 stearate; polyglyceryl-10 oleate; polyglyceryl-10 dipalmitate, polyglyceryl-10 caprylate/caprate; polyglyceryl-10 laurate, or mixtures thereof.

In one embodiment, the solvent is an aqueous or non-aqueous solvent, or a mixture thereof. In one particular embodiment, the aqueous solvent is water, aqueous alcohols, ammonia water, acid solutions, salt solutions, water-miscible organic solvents in water or mixtures thereof. Suitable non-aqueous solvent is a univalent or polyvalent alcohols, alkanolamines, glycol ethers, or mixtures thereof.

In another embodiment of the detergent composition may further contain one or more anionic surfactants.

In another particular embodiment, the anionic surfactant may be one or more of a C11-C18 alkyl benzene sulfonates, C10-C20 branched-chain and random alkyl sulfates, C10-C18 alkyl ethoxy sulfates, mid-chain branched alkyl sulfates, mid-chain branched alkyl alkoxy sulfates, C10-C18 alkyl alkoxy carboxylates containing 1-5 ethoxy units, modified alkylbenzene sulfonate, C12-C20 methyl ester sulfonate, C10-C18 alpha-olefin sulfonate, C6-C20 sulfosuccinates, fatty methyl ester sulphonates and/or alkyl ethyoxy sulphates (AES) and/or alkyl polyalkoxylated carboxylates (AEC), or mixtures thereof. In a further embodiment, the anion surfactant may be alkyl ethoxy-sulfates, sodium laureth sulfate, sodium cumenesulfonate, alkyl benzene sulfonates, sodium C10-13 alkyl benzenesulfonate, MEA dodecylbenzenesulfonate, MEA-laureth sulfate, or mixtures thereof.

Other anionic surfactants usable in the present detergent composition include “green” anionic surfactants, such as sodium coco sulfate, ammonium coco sulfate, sodium lauryl glucosides hydroxypropyl sulfonate, ammonium lauryl glucosides hydroxypropyl sulfonate, sodium decyl glucosides hydroxypropyl sulfonate, ammonium decyl glucosides hydroxypropyl sulfonate or mixtures thereof. Other alkyl sulfates, such as sodium lauryl sulfate, sodium dodecyl sulfate, ammonium lauryl sulfate may also be formed from naturally occurring acids as well.

In one embodiment, the detergent composition further contains a builder, chelant, antioxidants or mixture thereof.

In one embodiment, the detergent composition further contains a polymer selected from a polycarboxylates, polyacrilates (PAA), carboxymethyl cellulose, poly-ethylene-imine (PEI), PEG-136 polyvinyl acetate, polyethyleneimine ethoxylates, poly vinyl alcohol, styrene, acrylates copolymers, sodium polyacrylate, amphiphilic alkoxylated grease cleaning polymer, clay soil cleaning polymers, soil release polymers, soil suspending polymers, acrylic polymers, or mixtures thereof.

In one embodiment, the detergent composition further contains an enzyme contains one or more of a proteases, amylases, cellobiases, cellulases, lipases, xylogucanases, pectate lyases, mannanases, bleaching enzymes, cutinases, lipolytically active enzymes, glycosyl hydrolases, enzymatic actives, or mixtures thereof.

In another embodiment, the detergent composition further contains whitening agent or perfume, where, in one aspect, the whitening agent or perfume is Limonene, linalool, parfum, fluorescent whitening agent, fragrances, fragrance oils, perfumes, essential oils, natural oils thereof, natural extracts thereof having fragrance/perfume properties, or mixtures thereof.

In one embodiment, the detergent composition further contains an emollient, wherein the emollient contains a wax, oil or mixtures thereof. In a further aspect, the emollient is an oil that includes an ester oil, an ether oil, or mixtures thereof.

In a further embodiment, the detergent composition further containing a preservative system, wherein the preservative system contains benzoic acid, sodium benzoate, benzyl alcohol, sorbic acid or salts thereof, parabens, dehydroacetic acid, bronopol, triclosan, imidazolidinyl urea, PHMB, phenoxyethanol, DMDMH, ethylhexylglycerol, isothiazolones, chlorhexidine, diazolidinyl urea, chlorphenesin, sodium hydroxymethylglycinate, benzethonoium chloride, IPBC (iodopropynyl butylcarbamate), salicylic acid, natural acids or mixtures thereof.

One aspect of the present disclosure provides, a detergent composition, contains (a) 0.1 w/w %-35 w/w % of a of a polyglyceryl fatty acid ester or a mixture of polyglyceryl fatty acid esters; (b) 1 w/w %-70 w/w % of an anionic surfactant, or a mixture of anionic surfactants; (c) 1 w/w %-10 w/w % or a builder, chelant, antioxidant present or a mixture thereof; (d) 0 w/w %-10 w/w % of a polymer; (e) 0 w/w %-5 w/w % of an enzyme; (f) 0 w/w %-5 w/w % of a whitening agents or perfumes or a mixture thereof; and (g) 0.5 w/w %-15 w/w % of a solvent; each component present in an amount based on the total weight of the detergent composition.

In yet another aspect of the present disclosure provides, a detergent composition, contains (a) 0.1 w/w %-20 w/w % of a of a polyglyceryl fatty acid ester or a mixture of polyglyceryl fatty acid esters; (b) 1 w/w %-40 w/w % of an anionic surfactant, or a mixture of anionic surfactants; (c) 2 w/w %-5 w/w % or a builder, chelant, antioxidant present or a mixture thereof; (d) 1 w/w %-5 w/w % of a polymer; (e) 0.1 w/w %-3 w/w % of an enzyme; (f) 0.1 w/w %-5 w/w % of a whitening agents or perfumes or a mixture thereof; and (g) 0.5 w/w %-10 w/w % of a solvent; each component present in an amount based on the total weight of the detergent composition.

In one aspect, the pH of the detergent composition is between 3 and 12.

In a further embodiment of the detergent composition, provides a composition in the form of a liquid, gel, suspension, capsule, or powder.

In another embodiment, the detergent composition is enclosed within a water soluble pouch material.

In yet another embodiment, the detergent composition further contains at least one or more additional ingredients from a bleaching agent, surfactant, enzyme stabilizers, optical brighteners, gray inhibitors, hueing dyes, particulate material, perfume and other odor control agents, colorants, washing aids, hydrotropes, suds suppressors, fabric care benefit agents, pH adjusting agents, dye transfer inhibiting agents, non-fabric substantive dyes, antiredeposition agents, viscosity modifier, processing aid, bleaching agent, bleaching activators, bleaching catalysts, amphiphilic alkoxylated grease cleaning polymer, clay soil cleaning polymers, soil release polymers, soil suspending polymers, thickening agent, cleaning aid/agent, detergent additives, or mixtures thereof.

In another aspect, the present disclosure provides an automatic dishwashing product containing the detergent composition as described herein, and (b) water, aqueous solvent, non-aqueous solvent or mixtures thereof.

In one particular embodiment, automatic dishwashing product is useful for dishwashing products, laundry products, dish hand-washing products, or other household detergent-based compositions.

In one particular embodiment, the end-user formulation or automatic dishwashing product contains between 0.1 w/w %-85 w/w %, by weight of the detergent composition, based on the weight of the formulation.

In a further embodiment, the detergent composition is useful for hygiene or consumer/home care products containing a dishwashing liquid, laundry detergent, hand washing liquid, or other household detergent-based compositions.

These and other aspects will become apparent when reading the detailed description.

### DETAILED DESCRIPTION

It has now been surprisingly found that polyglyceryl fatty acid esters may be used to supplemental or replace other non-ionic surfactants for compositions requiring such surfactants. The addition of polyglyceryl fatty esters, have also shown to work well in combination with other surfactants for compositions and end-user formulations. The present disclosure provides a composition whereby the surfactant contains one or more of a polyglyceryl fatty ester and may further contains one or more anionic surfactants or amphoteric surfactants, aiding the properties of detergent-based compositions, without affecting the properties of the formulation itself.

Additionally, the aesthetic properties and rheological behavior of polyglycerol esters means that additional components (such as humectants, viscosity modifiers), although not required; may be added to the end user formulation, if desired, without affecting the properties of the formulation itself.

In accordance to the present disclosure, the term “builders” herein, refer to substances which deal with hard-water molecules during the washing process, allowing surfactants get on with their job of removing stains. They are responsible for removing the hardness ions so the surfactant can be fully functional.

In accordance to the present disclosure, the term “anti-redeposition agents” herein, refer to soil release substances which keep the soil particles suspended in the wash liquor so they do not get deposited back on the fabric.

In accordance to the present disclosure, the term “enzymes” herein, refer substances which are naturally occurring proteins that break down stains into smaller pieces to make them easier to remove. There are several different types of enzymes present in your washing detergent, each of which works to break down and remove a specific type of stain like grass, blood, tough stain removal, color and fabric care, grease, oils (starch based), gravy by breaking them down to smaller, easily removable components, help whiten and brighten, protein stains, and the like.

In accordance to the present disclosure, the term “surfactants” herein, refer to substances having a core stain removing function in a detergent composition. This refers to any substance which removes anything greasy from fabrics, and they work well on stains and food residues.

The term “HLB” herein, refers to “hydrophilic-lipophilic balance”. The HLB value expresses the water and oil solubility of, in particular, non-ionic, emulsifiers (i.e. it expresses the lipophilic and hydrophilic properties of an emulsifier, which are determined by the different parts of the emulsifier molecules). The higher the HLB of an emulsifier, the more hydrophilic and water soluble it is. According to the Griffiths method, HLB is calculated via: HLB=(molecular weight of hydrophilic head-group/total molecular weight)*20.

The term “waxes” herein, refers to naturally-occurring or synthetic waxes, of which typical examples include stearyl alcohol, hydrocarbon waxes, waxes of plant or animal origin, their synthetic analogues or derivatives, or silicone waxes. Waxes are widely available, and by suitable selection of the waxes themselves and their concentrations in the formulation can effectively obtain either a soft solid or a firm solid. Conventionally, waxes are applied to a variety of materials and mixtures which have similar physical properties, namely that: they are solid at about 30° C. to about 40° C.; they melt to a mobile liquid at a temperature above 30° C., and below 95° C.; generally in a temperature range of 40° C.-90° C.; and they are water-insoluble and remain water-immiscible when heated above their melting point.

The term “oils” herein, refers to an organic compound which at about 20° C. is both liquid and water-insoluble. In the context of the disclosure, insolubility in water is understood to be a solubility of less than 10 w/w % at about 20° C. Typically, the solubility of less than 1 w/w %, more particularly less than 0.1 w/w %, in particularly less than 0.01 w/w %.

The term “aqueous alcohol” herein, refers to saturated, unsaturated, straight or branched hydrocarbon chain having C1-C4 carbon atoms and at least one hydroxyl groups, wherein the hydrocarbon chain may optionally contains one or several heteroatoms (such as oxygen or sulfur). The aqueous alcohol will contain at a minimum an amount of water.

The term “green surfactant’ used herein is the Renewable Carbon Index (RCI). The RCI is the percentage of the carbon atoms in each surfactant molecule that originate from renewable resources (typically oil-producing plants) rather than from fossil resources. So, for example, the surfactant sodium coco-sulfate, having a tail-group carbon chain derived entirely from palm kernel oil and/or coconut oil, and having no carbon in the surfactant head-group, has an RCI value of 100. Under the RCI definition of ‘greenness’, this can be considered to be a ‘100% green’ surfactant. In contrast, an alkyl benzenesulfonate surfactant, having a tail-group carbon chain derived entirely from fossil resources, has an RCI value of 0. Under the RCI definition of ‘greenness’, this can be considered to be a ‘100% black’ surfactant. If we consider the surfactant sodium laureth sulfate with 3 moles of ethoxylation, this may have an RCI value of 0 if the tail-group carbon chain is derived from fossil resources or it may have an RCI value of 67 if the tail-group carbon chain is derived from renewable plant resources. This calculation assumes that the carbon in the ethylene oxide portion of the surfactant head-group originates from fossil resources. For non-ionic surfactants, a similar calculation can be done. For a typical alcohol ethoxylate surfactant such as C12EO6, the RCI value is 0 if the tail-group carbon chain is derived from fossil resources. If the tail-group carbon chain is derived from renewable resources, the RCI value is 50 because the carbon in the ethylene oxide head-group is invariably derived from fossil resources. Obtaining non-ionic surfactants with an RCI value of 100 suitable for use in the detergent applications described herein has been hitherto technically difficult to achieve. The RCI value of the polyglyceryl fatty acid esters non-ionic surfactants described herein is 100.

The present disclosure encompasses a detergent composition containing (a) a surfactants and a solvent; wherein the surfactant contains one or more of a polyglyceryl fatty acid ester.

The detergent composition contains (a) a surfactant and a carrier wherein the surfactant contains one or more of a polyglyceryl fatty ester.

Polyglycerol esters useable in the present disclosure may be formed from saturated, unsaturated, natural or synthetic fatty acids, and the like. For instance, saturated fatty acids include caprylic acid, capric acid, lauric acid, myristic acid, palmitic acid, stearic acid, arachidic acid, behenic acid, lignoceric acid, cerotic acid, oleic acid, decaoleic acid, ricinoleic acid, or combinations thereof, or derivatives thereof, and the like.

Furthermore, the polyglyceryl fatty ester contains one or more of a polyglyceryl fatty ester, wherein the polyglyceryl fatty ester is derived from (a) a polyglycerol component built up from 2 to 18 molecules of glycerol, based on an average, and (b) a fatty acid selected from the group consisting of caprylic acid, capric acid, lauric acid, myristic acid, palmitic acid, stearic acid, arachidic acid, behenic acid, lignoceric acid, cerotic acid, oleic acid, decaoleic acid, ricinoleic acid, or mixtures thereof and the like.

Typically, surfactant containing a polyglyceryl fatty ester having an HLB between 1 and 9 or one or more of a polyglyceryl fatty ester having an HLB between 9-16. Suitably, the surfactant contains a polyglyceryl fatty ester having an HLB between 12-16.

Examples of polyglyceryl ester, having an HLB value between 1-9 or 10-16, includes, but are not limited to, polyglyceryl monodecaoleate such as polyglyceryl-10 decaoleate; polyglyceryl monooleate such as polyglyceryl-2-monooleate, polyglyceryl-3 monooleate, polyglyceryl-4 monooleate, polyglyceryl-6 monooleate, or polyglyceryl-10 monooleate; polyglyceryl dioleate such as polyglyceryl-2 dioleate, polyglyceryl-3 dioleate, polyglyceryl-5 dioleate, polyglyceryl-6 dioleate or polyglyceryl-10 dioleate; polyglyceryl trioleate such as polyglyceryl-5 trioleate or polyglyceryl-10 trioleate; polyglyceryl tetraoleate such as polyglyceryl-2 tetraoleate, polyglyceryl-6 tetraoleate, or polyglyceryl-10 tetraoleate; polyglyceryl pentaoleate such as polyglyceryl-4 pentaoleate, polyglyceryl-6 pentaoleate, or polyglyceryl-10 pentaoleate; polyglyceryl heptaoleate such as polyglyceryl-6 heptaoleate, polyglyceryl-10 heptaoleate; polyglyceryl monostearate such as polyglyceryl-2 monostearate, polyglyceryl-3 monostearate, polyglyceryl-4 monostearate, polyglyceryl-5 monostearate, polyglyceryl-6 monostearate or polyglyceryl-10 monostearate; polyglyceryl distearate such as polyglyceryl-2 distearate, polyglyceryl-3 distearate, polyglyceryl-4 distearate, polyglyceryl-6 distearate, or polyglyceryl-10 distearate; polyglyceryl tristearate such as polyglyceryl-4 tristearate, polyglyceryl-5 tristearate, polyglyceryl-6 tristearate, or polyglyceryl-10 tristearate; polyglyceryl tetrastea rate such as polyglyceryl-2 tetrastearate; polyglyceryl pentastearate such as polyglyceryl-4 pentastearate, polyglyceryl-6 pentastearate, or polyglyceryl-10 pentastearate; polyglyceryl heptastearate such as polyglyceryl-10 heptastearate; polyglyceryl isostearate such as polyglyceryl-2 isostearate, polyglyceryl-3 isostearate, polyglyceryl-4 isostearate, polyglyceryl-6 isostearate, or polyglyceryl-10 isostearate; polyglyceryl diisostearate such as polyglyceryl-2 diisostearate. polyglyceryl-3 diisostearate, polyglyceryl-4 diisostearate, polyglyceryl-6 diisostearate, polyglyceryl-10 diisostearate, or polyglyceryl-15 diisostearate; polyglyceryl triisostearate such as polyglyceryl-2 triisostearate, polyglyceryl-3 triisostearate, polyglyceryl-5 triisostearate, polyglyceryl-10 triisostearate; polyglyceryl tetraisostearate such as polyglyceryl-2 tetraisostearate; polyglyceryl caprylate such as polyglyceryl-2 caprylate, polyglyceryl-3 caprylate, polyglyceryl-4 caprylate, polyglyceryl-6 caprylate, or polyglyceryl-10 caprylate; polyglyceryl dicaprylate such as polyglyceryl-5 dicaprylate; polyglyceryl sesquicaprylate such as polyglyceryl-2 sesquicapyrlate; polyglyceryl octacaprylate such as polyglyceryl-6 octacaprylate; polyglyceryl caprate such as polyglyceryl-2 caprate, polyglyceryl-3 caprate, polyglyceryl-4 caprate, polyglyceryl-5 caprate, polyglyceryl-6 caprate, polyglyceryl-10 caprate: polyglyceryl dicaprate such as polyglyceryl-3 dicaprate or polyglyceryl-6 dicaprate; polyglyceryl caprylate/caprate such as polyglyceryl-4 capyrlateicaprate, polyglyceryl-6 caprylate/caprate, or polyglyceryl-10 caprylate/caprate; polyglyceryl palmitate such as polyglyceryl-2 palmitate, polyglyceryl-3 palmitate, polyglyceryl-6 palmitate or polyglyceryl-10 palmitate; polyglyceryl dipalmitate such as polyglyceryl-6 dipalmitate or polyglyceryl-10 dipalmitate; polyglyceryl tetrabehenate such as polyglyceryl-6 tetrabehenate; polyglyceryl myristate such as polyglyceryl-6 myristate or polyglyceryl-10 myristate; polyglyceryl rincinoleate such polyglyceryl-6 polyricinoleate or polyglyceryl-10 ricinoleate; polyglyceryl-3-laurate, polyglyceryl-4 laurate, polyglyceryl-10 laurate, other derivatives thereof, or mixtures thereof, and the like.

Exemplary polyglyceryl fatty acid esters include one or more of a polyglyceryl-10 decaoleate, polyglyceryl-3 monostearate, polyglyceryl-6 distearate, polyglyceryl-10 stearate, polyglyceryl-10 oleate, polyglyceryl-10 dipalmitate, polyglyceryl-10 caprylate/caprate, polyglyceryl-10 laurate or mixtures thereof.

The polyglyceryl fatty acid esters generally are present in a carrier in the detergent composition. The carrier is used to disperse the polyglyceryl fatty acid ester a larger end-use formulation. Typically carriers include a solvent for the polyglyceryl ester. Suitable solvents include an aqueous solvent or non-aqueous solvent.

Examples of aqueous solvent include, but are not limited to, water, aqueous alcohols, ammonia water, acid solutions, salt solutions, water-miscible organic solvents in water, glycols, or mixtures thereof and the like.

Examples of non-aqueous solvents include, but are not limited to, univalent or polyvalent alcohols, alkanolamines, glycol ethers or mixtures thereof and the like. Generally the non-aqueous solvents are typically miscible with water when mixed with water.

Suitably, some non-aqueous solvents include, glycerin, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl, or propyl ether, dipropylene glycol monomethyl or ethyl ether, diisopropylene glycol monomethyl or ethyl ether, methoxy-, ethoxy-, or butoxytriglycol, 1-butoxyethoxy-2-propanol, 3-methyl-3-methoxybutanol, propylene glycol t-butyl ether, or mixtures thereof and the like. For example, non-aqueous solvents may be used in the liquid washing and cleaning agents.

It may be desired for the detergent composition to further contain one or more additional surfactants. The additional surfactant used may be an anionic, an amphoteric, a zwitterionic surfactant, a nonionic surfactant, a cationic surfactant or compatible mixture thereof.

Typically, the additional surfactant used is an anionic surfactant. When present, the anionic surfactant may be used in an amount between 1 w/w %-70 w/w % by weight of the surfactants of the surfactants in the detergent composition. Furthermore, more typical ranges for the anionic surfactant may be between 2 w/w %-60 w/w %, suitably 3 w/w %-40 w/w % or typically 5 w/w %-30 w/w %, based on the weight of the total detergent composition.

A variety of anionic surfactants may be used. Suitably, the anionic surfactant include, but are not limited to, one or more of an anionic surfactant selected from the group consisting of: C11-C18 alkyl benzene sulfonates, C10-C20 branched-chain and random alkyl sulfates, C10-C18 alkyl ethoxy sulfates, mid-chain branched alkyl sulfates, mid-chain branched alkyl alkoxy sulfates, C10-C18 alkyl alkoxy carboxylates containing 1-5 ethoxy units, modified alkylbenzene sulfonate, C12-C20 methyl ester sulfonate, C10-C18 alpha-olefin sulfonate, C6-C20 sulfosuccinates, fatty methyl ester sulphonates and/or alkyl ethyoxy sulphates (AES) and/or alkyl polyalkoxylated carboxylates (AEC), and mixtures thereof, and the like.

Examples of anionic sulfonate or sulfonic acid surfactants suitable for use herein include, but are not limited to, the acid and salt forms of linear or branched C5-C20, more suitably C10-C16, typically C11-C13 alkylbenzene sulfonates, C5-C20 alkyl ester sulfonates, C6-C22 primary or secondary alkane sulfonates, C5-C20 sulfonated polycarboxylic acids, or mixtures thereof and the like.

Examples of anionic sulphate salts suitable for use in compositions of the detergent composition include, but are not limited to, primary and secondary alkyl sulphates, having a linear or branched alkyl or alkenyl moiety having from C9-C22 atoms, more suitably from C12-C18 atoms; beta-branched alkyl sulphate surfactants; or mixtures thereof and the like.

Examples of mid-chain branched alkyl sulphates or sulfonates include, but are not limited to, the C5-C22, suitably C10-C20 mid-chain branched alkyl primary sulfates. When mixtures are used, a suitable average total number of carbon atoms for the alkyl moieties being within the range of from 14 to 18. Suitably, mono-methyl-branched primary alkyl sulfates are selected from the group consisting of the 3-methyl to 13-methyl pentadecanol sulfates, the corresponding hexadecanol sulfates, or mixtures thereof, and the like. Alternatively, dimethyl derivatives or other biodegradable alkyl sulfates having light branching can similarly be used.

Exemplary examples of anionic surfactants includes, but is not limited to, a surfactant one or more of an anionic surfactant containing an alkyl ethoxy-sulfates, sodium laureth sulfate, sodium cumenesulfonate, alkyl benzene sulfonates, sodium C10-C13 alkyl benzenesulfonate, MEA dodecylbenzenesulfonate, MEA-laureth sulfate, MEA-palm kernelate, or mixtures thereof, and the like. Typically, the anionic surfactants are present in the form of their salts with alkanolamines or alkali metals such as sodium and potassium, and/or are neutralized with alkanolamines such as monoethanolamine or triethanolamine, and are fully soluble in a liquid phase.

Other anionic surfactants which are considered “green” or from renewable resources can be used as well. These include anionic surfactancts based on coco sulfate and other alkyl sulfates from naturally occurring acids, lauryl glucosides hydroxypropyl sulfonate, decyl glucosides hydroxypropyl sulfonate, or mixtures thereof. Generally these anionic surfactants are in the form of alkali metal salts, ammonium salts and/or are neutralized with alkanolamines such as monoethanolamine or triethanolamine. These “green” anionic surfactants, when used with the polyglyceryl esters can yield detergent compositions which are derived from natural, renewable or green resources. Other anionic surfactants such as sodium coco-sulfate, sodium lauryl sulfate, sodium dodecyl sulfate, ammonium coco-sulfate, ammonium lauryl sulfate and sodium dodecyl sulfate may be used.

If desired, the cationic surfactant(s) used may include, but are not limited to, water-soluble, water-dispersible or water-insoluble. Such cationic surfactants have at least one quaternized nitrogen atom and at least one long-chain hydrocarbyl group. Compounds containing two, three or even four long-chain hydrocarbyl groups are also included. Examples include alkyltrimethylammonium salts, such as C12 alkyltrimethylammonium chloride, hydroxyalkyl substituted analogs thereof, mixtures thereof and the like.

Suitable amphoteric or zwitterionic detersive surfactants of use in the fluid detergent compositions. Non-limiting examples of suitable zwitterionic or amphoteric surfactants are described in U.S. Pat. No. 5,104,646 (Bolich Jr. et al.), U.S. Pat. No. 5,106,609 (Bolich Jr. et al.).

Examples of amphoteric surfactants include, but are not limited to, surfactants broadly described as derivatives of aliphatic secondary and tertiary amines in which the aliphatic radical can be straight or branched chain and wherein one of the aliphatic substituents contains from C8-C18 atoms and one contains an anionic group such as carboxy, sulfonate, sulfate, phosphate, or phosphonate. Suitable amphoteric detersive surfactants for use in the present disclosure include, but are not limited to: cocoamphoacetate, cocoamphodiacetate, lauroamphoacetate, lauroamphodiacetate, and mixtures thereof and the like.

As with the anionic surfactants, the amphoteric surfactants can be “green”, natural or derived from renewable resources. Exemplary “green” amphoteric, include, for example, cocoamidopropyl betaine, cocoamidopropyl hydroxysultaine, cocobetaine, alkyl amine oxides. Also there are the 100% natural carbon carboxylate surfactants, that are anionic at low pH and non-ionic (with limited solubility) at high pH (fatty acids, acyl glycinates, acyl glutamates, alkyl amphoacetates or diacetates).

Examples of zwitterion surfactants include, but are not limited to, surfactants broadly described as derivatives of aliphatic quaternary ammonium, phosphonium, and sulfonium compounds, in which the aliphatic radicals can be straight or branched chain, and wherein one of the aliphatic substituents contains from C8-C18 atoms and one contains an anionic group such as carboxy, sulfonate, sulfate, phosphate or phosphonate. zwitterionics such as betaines are suitable for this disclosure.

The detergent composition may further contain a builder, chelant and/or antioxidants. Examples of builders, chelants or antioxidants include, but are not limited to, one or more of an acrylic polymers, borates or boric acid, (i.e. calcium chloride, magnesium chloride, sodium chloride), citrates (i.e. sodium citrate, MEA citric acid salt), formates (i.e. calcium formate, sodium formate), silicates, sulfites (i.e. sodium bisulfites), sulfates (i.e. sodium sulfate), gluconic acid and polyacrylic acid, zeolites, glycerin, EDTA, carbonates, salts of organic di- and polycarboxylic acids, or mixtures thereof and the like.

The detergent composition may further contain one or more polymer(s) including, but not limited to, one or more of a polycarboxylates, polyacrilates (PAA), carboxymethyl cellulose, polyethyleneimine (PEI), peg-136 polyvinyl acetate, polyethyleneimine ethoxylates, poly vinyl alcohol, styrene, acrylates copolymers, sodium polyacrylate, amphiphilic alkoxylated grease cleaning polymer, clay soil cleaning polymers, soil release polymers, soil suspending polymers, acrylic polymers, monoethanolamine borate, PEG, polyvinyl acetate co-polymers, glycerin, or mixtures thereof and the like.

Examples of other polymers includes, but is not limited to, nonionic cellulose ethers (such as methyl cellulose and methylhydroxypropyl cellulose), polymers, known from the existing art, of phthalic acid and/or terephthalic acid or their derivatives, in particular polymers of ethylene terephthalates and/or polyethylene and/or polypropylene glycol terephthalates or anionically and/or nonionically modified derivatives thereof. For example, suitable derivatives encompass the sulfonated derivatives of the phthalic acid and terephthalic acid polymers.

The detergent composition for further contains an enzyme wherein the enzyme contains one or more of a proteases, amylases, cellobiases, cellulases, lipases, xylogucanases, pectate lyases, mannanases, bleaching enzymes, cutinases, lipolytically active enzymes, glycosyl hydrolases, enzymatic actives, or mixtures thereof, and the like.

The detergent composition contains enzymes ingredient to provide cleaning performance and/or fabric care benefits. Such compositions have a pH of from 6 to 12. Suitable enzymes include but are not limited to, proteases (metalloproteases and/or serine proteases, including neutral or alkaline microbial serine proteases, such as subtilisins or proteases those derived from Bacillus gibsonii or Bacillus Lentus), amylases (such as α-amylases, isoamylases, pullulanases, and pectinases), cellobiases (such as cellobiohydrolases, endoglucanases, and β-glucosidases), cellulases (bacterial or fungal origin), lipases, xylogucanases, pectate lyases, mannanases, bleaching enzymes, cutinases, lipolytically active enzymes, glycosyl hydrolases and mixtures thereof and the like. Enzymatic active substances obtained from bacterial strains or fungi, such as Bacillus subtilis, Bacillus licheniformis, Streptomyceus griseus, and Humicola insolens, are also particularly suitable, or mixtures thereof and the like.

Examples of suitable commercially available protease enzymes include: those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes NS (Denmark); those sold under the tradename Maxatase®, Maxacal®, Maxapem®, Properase®, Purafect®, Purafect Prime®, Purafect Ox®, FN3®, FN4®, Excellase® and Purafect OXP® by Genencor International; those sold under the tradename Opticlean® and Optimase® by Solvay Enzymes; KAP (Bacillus alkalophilus subtilisin with mutations A230V+S256G+S259N) from Kao, or mixtures thereof and the like.

Examples of exemplary enzymes include, one or more of a cellulose, proteases, amylases, lipase, mannanase, pectate lyase, xyloglucanase, enzymatic active, or mixtures thereof and the like.

Examples of suitable amylases are alpha-amylases, including those of bacterial or fungal origin. Chemically or genetically modified mutants (variants) are included. Typically, alkaline alpha-amylase is derived from a strain of Bacillus, such as Bacillus licheniform is, Bacillus amyloliquefaciens, Bacillus stearothermophilus, Bacillus subtilis, or other Bacillus sp., (such as Bacillus sp. NCIB 12289, NCIB 12512, NCIB 12513, sp 707, DSM 9375, DSM 12368, DSMZ no. 12649, KSM AP1378, KSM K36 or KSM K38), or mixtures thereof and the like.

The detergent composition may contain a cellulase, whereby examples of suitable cellulases include those of bacterial or fungal origin. Chemically modified or protein engineered mutants are included. Suitable cellulases include, but are not limited to, cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum. Commercially available cellulases include Celluzyme®, and Carezyme® (Novozymes NS), Clazinase®, and Puradax HA® (Genencor International Inc.), KAC-500(B)® (Kao Corporation), or mixtures thereof and the like.

The detergent composition may contain a lipase, whereby examples of suitable lipases include those of bacterial or fungal origin. Chemically modified or protein engineered mutants are included. Examples of useful lipases include, but are not limited to, lipases from Humicola (synonym Thermomyces), e.g., from H. lanuginosa (T. lanuginosus), or from H. insolens, a Pseudomonas lipase, e.g., from P. alcaligenes or P. pseudoalcaligenes, P. cepacia, P. stutzeri, P. fluorescens, Pseudomonas sp. strain SD 705, P. wisconsinensis, a Bacillus lipase, e.g., from B. subtilis, B. stearothermophilus, B. pumilus, or mixtures thereof, and the like.

Examples of suitable xyloglucanase enzymes have enzymatic activity towards both xyloglucan and amorphous cellulose substrates, wherein the enzyme is a glycosyl hydrolase (GH) is selected from GH families 5, 12, 44 or 74; or mixtures thereof and the like.

Examples of suitable pectate lyases include, but are not limited to, either wild-types or variants of Bacillus-derived pectate lyases (CAF05441, AAU25568) sold under the tradenames Pectawash®, Pectaway® and X-Pect® (from Novozymes NS, Bagsvaerd, Denmark).

Examples of suitable mannanases include, but are not limited to, those sold under the tradenames Mannaway® (from Novozymes NS, Bagsvaerd, Denmark), and Purabrite® (Genencor International Inc., Palo Alto, Calif.), or mixtures thereof and the like.

In addition, if desired, the enzyme used may be one or more of a bleaching enzyme. Examples of suitable bleach enzymes include, but are not limited to, oxidoreductases, for example oxidases such as glucose, choline or carbohydrate oxidases, oxygenases, catalases, peroxidases, like halo-, chloro-, bromo-, lignin-, glucose- or manganese-peroxidases, dioxygenases or laccases (phenoloxidases, polyphenoloxidases). Additionally, suitable commercial products are sold under the Guardzyme® and Denilite® ranges from Novozymes. Advantageously, additionally organic, and/or aromatic compounds may be incorporated with the bleaching enzyme; these compounds interact with the bleaching enzyme to enhance the activity of the oxidoreductase (enhancer) or to facilitate the electron flow (mediator) between the oxidizing enzyme and the stain typically over strongly different redox potentials.

Other suitable bleaching enzymes include, but are not limited to, perhydrolases, which catalyze the formation of peracids from an ester substrate and peroxygen source. Suitable perhydrolases include variants of the Mycobacterium smegmatis perhydrolase, variants of so-called CE-7 perhydrolases, and variants of wild-type subtilisin Carlsberg possessing perhydrolase activity.

Examples of suitable cutinases include, but are not limited to, by E.C. Class 3.1.1.73, typically displaying at least 90%, or 95%, or most suitably at least 98% identity with a wild-type derived from one of Fusarium solani, Pseudomonas Mendocina, Humicola Insolens, or mixtures thereof and the like.

For examples, enzymes such as Lipase help remove grease and oil; cellulase whitens and brightens; amylase (removes starch-based soils; and protease removes protein stains.

Furthermore, the detergent composition may further contain other ingredients common to detergent compositions which include ingredients such as a whitening agent or perfume. Exemplary whitening agent or perfume includes, but is not limited to, one or more of a Limonene, linalool, fluorescent whitening agents, parfum, fragrances (natural or synthetically produced), fragrance oils, perfumes, essential oils, and mixtures thereof; natural oils thereof, natural extracts, substances having fragrance/perfume properties, or mixtures thereof, and the like.

Examples of essential oils, include but are not limited to, balsam oil, pine oil, citrus oil, lime oil, jasmine oil, rose oil, muscatel sage oil, chamomile oil, lavender oil, clove oil, melissa oil, mint oil, cinnamon leaf oil, lime blossom oil, Wacholderbeeröl, vetiver oil, olibanum oil, galbanum oil and labdanum oil orange blossom oil, neroli oil, orange peel oil, sandalwood oil, anise oil, aniseed oil, arnica blossom oil, basil oil, bay oil, Chamberlain pacablútentöl, silver fir oil, noble fir cone oil, elemi oil, eucalyptus oil, fennel oil, pine needle oil, galbanum oil, geranium oil, ginger grass oil, Guajakholzöl, Gurjunbalsamöl, helichrysum oil, Ho oil, ginger oil, iris oil, cajeput oil, calamus oil, camomile oil, camphor oil, Kanagaöl, cardamom oil, cassia oil, pine needle oil, Kopalvabalsamöl, coriander oil, spearmint oil, caraway oil, Kuminöl, lemongrass oil, ambrette seed oil, myrrh oil, mustard seed oil, clove oil, neroli oil, niaouli oil, olibanum oil, oregno oil, palmarosa oil, patchouli oil, petitgrain oil, pepper oil, peppermint oil, pimento oil, pine oil, rose oil, rosemary oil, sandalwood oil, celery oil, sternanis oil, thuja oil, thyme oil, verbena, vetiver oil, wormwood oil, wintergreen oil, ylang-ylang oil, hyssop oil, cinnamon oil, cinnamon leaf oil, and cypress oil or mixtures thereof and the like.

For example, perfumes are typically incorporated at a level from 0.001%-10%, suitably from 0.01%-5%, typically from 0.1%-3% by on the total weight of the detergent composition. The perfume used may contain a perfume microcapsule and/or a perfume nanocapsule. In other embodiments, the fluid detergent composition contains odor control agents such as uncomplexed cyclodextrin.

The detergent composition may include one or more additional substances as discussed above. Namely in addition to the above discussed benefits, substances such as perfumes may improve the smell of articles washed with the detergent; brighteners may improve the color or shine of an article; buffers may maintain the acidity balance in the water; and suds suppressors to prevent excess suds from spoiling the wash.

In another aspect of the present disclosure, the detergent composition may be essentially free of dyes perfumes, chlorine, phosphates, ethanolamine, and optical brighteners making them suitable for sensitive skin, and/or renewable by using materials from a natural source, resulting in a more bio-based detergent composition for end-user products.

The composition may further contain an emollient, whereby the emollient contains a wax, an oil, or mixtures thereof, and the like.

A variety of waxes may be suitable, including but not limited to, silicone polymers, hydrocarbons, linear fatty alcohols, esters of fatty acids or glyceride derivatives, mixtures thereof, or complexes thereof, and the like.

Examples of waxes, include but are not limited to, castor wax, beeswax, carnauba and candelilla waxes, which are of vegetable origin and mineral waxes from fossil remains other than petroleum. Montan wax, which is an example of mineral wax, includes non-glyceride esters of carboxylic acids, hydrocarbons and other constituents. Other naturally available waxes include spermeceti wax, ozokerite, ceresin, baysberry, synthetic waxes, paraffin wax, silicone waxes or mixtures thereof, and the like.

Examples of oil emollients include, but are not limited to, ester oils, an ether oil or mixtures thereof, and the like. The term “ester oil” herein, refers to oils as above-defined, which contains at least one ester group. This means that also esters of carbonic acids are ester oils according to the disclosure. Further, the term “ether oil” herein, refers to oils as above-defined, which contains at least one ether group.

Examples of oils include, but are not limited to, glycerides (such as e.g., triglycerides), hydrocarbons (such as e.g., petrolatum); silicone oils (such as e.g., dimethicone), dialkyl ethers, alkyl esters, dialkyl carbonates, dialkyl tartrates, natural oils (such as vegetable oils), and the like. In dialkyl ethers, alkyl esters and dialkyl carbonates such as dicaprylyl carbonate, ethylhexyl carbonate, dihexyl carbonate; the alkyl groups may be straight or branched and independently from each other typically have C2-C16 atoms. Generally, at least one of said alkyl groups has at least 6 carbon atoms, typically at least 8 carbon atoms. Optionally the oil may be an oil that has further functions such as an oil soluble sunscreen. Mixtures of oil components may also be used.

The emollient used includes, but is not limited to, a dialkyl ether such as dicaprylyl ether, or an alkyl ester, C12-C15 alkyl benzoates or C10-C16 dialkyl tartrates. Generally, the emollient is a C10-C16 dialkyl tartrate, specifically C12-C13 dialkyl tartrate.

The detergent composition may further contain a preservative system, whereby the preservative system contain one or more of a benzoic acid, sodium benzoate, benzyl alcohol, sorbic acid or salts thereof (i.e. potassium-sorbate), parabens, dehydroacetic acid, bronopol, triclosan, imidazolidinyl urea, PHMB, phenoxyethanol, DMDMH, ethylhexylglycerin, isothiazolones, chlorhexidine, diazolidinyl urea, chlorphenesin, sodium hydroxymethylglycinate, benzethonoium chloride, IPBC (iodopropynyl butylcarbamate), salicylic acid, organic acids, natural acids (such as citric, cinnamic, tartaric, malic, oxalic, lactic, ascorbic acids), essential oils, or mixtures thereof, and the like.

If a preservative is present, it may be present in the amount between 0.01 w/w %-15 w/w %, based on the weight of the total composition. Suitably, the preservative may be present in the amount between 0.1 w/w %-7 w/w %, based on the weight of the total composition.

In one aspect, the detergent composition of the present disclosure contains (a) 0.1 w/w %-35 w/w % of a polyglyceryl fatty acid ester surfactant or a mixture of polyglyceryl fatty acid esters (b) 1 w/w %-70 w/w % of an anionic surfactant, or a mixture of anionic surfactants; (c) 1 w/w %-10 w/w % or a builder, chelant, antioxidant or a mixture thereof; (d) 0 w/w %-10 w/w % of a polymer; (e) 0 w/w %-5 w/w % of an enzyme; (f) 0 w/w %-5 w/w % of a whitening agents or perfumes or a mixture thereof; and (g) 0.5 w/w %-15 w/w % of a solvent; each component present in an amount based on the total weight of the detergent composition present in the amount of each based on the total weight of the composition.

Alternatively, the detergent composition of the present disclosure contains (a) a surfactants containing one or more of a polyglyceryl fatty ester present in the amount of 0.1 w/w %-20 w/w %; (b) 1 w/w %-40 w/w % of an anionic surfactant, or a mixture of anionic surfactants; (c) 2 w/w %-5 w/w % or a builder, chelant, antioxidant or a mixture thereof; (d) 1 w/w %-5 w/w % of a polymer; (e) 0.1 w/w %-3 w/w % of an enzyme; (f) 0.1 w/w %-5 w/w % of a whitening agents or perfumes or a mixture thereof; and (g) 0.5 w/w %-10 w/w % of a solvent; each component present in an amount based on the total weight of the detergent composition present in the amount of each based on the total weight of the composition.

In one aspect, the composition may have a pH of the composition is between 3-12, suitably 3-10.

A further aspect of the present disclosure provides a detergent composition which may be in the form of a liquid, gel, suspension, capsule, or powder. Suitably, the composition is in the form of a liquid, gel or capsule. Additionally, the detergent composition may be enclosed within a water soluble pouch material or similar product thereof.

Additionally, when the detergent composition is in liquid form, the composition may optionally contain a hydrotrope in an effective amount of up to 15 w/w %, suitably 1 w/w %-10 w/w %, typically 3 w/w %-6 w/w % by weight, so that the fluid detergent compositions are compatible in water. Examples of suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, or mixtures thereof, and the like.

If the detergent composition is used to formulate liquid washing and cleaning agents, such compositions further contains a thickening agent. The thickening agent can encompass, for example, a polyacrylate thickener, xanthan gum, gellan gum, guar seed flour, alginate, carrageenan, carboxymethyl cellulose, bentonite, wellan gum, locust bean flour, agar-agar, tragacanth, gum arabic, pectins, polyoses, starch, dextrins, gelatin, casein or mixtures thereof, and the like. Additionally the use of altered natural substances such as modified starches and celluloses (carboxymethyl cellulose and other cellulose ethers, hydroxyethyl and -propyl cellulose, and seed flour ethers may be mentioned here by way of example) can, however, may also be used as thickening agents.

In another aspect, if desired, the detergent composition further contains at least one additional ingredients from a bleaching agent, surfactant, enzyme stabilizers, optical brighteners, gray inhibitors, hueing dyes, particulate material, perfume and other odor control agents, hydrotropes, suds suppressors, fabric care benefit agents, pH adjusting agents, dye transfer inhibiting agents, non-fabric substantive dyes, colorants, washing aids, antiredeposition agents, viscosity modifier, processing aid, bleaching agent, bleaching activators, bleaching catalysts, amphiphilic alkoxylated grease cleaning polymer, clay soil cleaning polymers, soil release polymers, soil suspending polymers, enzyme stabilizers, thickening agents, cleaning aid/agent, detergent additives, or mixtures thereof, and the like.

The presence of dye transfer inhibitors, for example, is used to help prevent dye from coming off one fabric and getting deposited on other. Examples of dye transfer inhibitors include, but are not limited to, PVP K-30, Chromabond S-100 (PVP with betaine functionality) Chromabond S-400 (PVP with nitrogen oxide functionality) from ISP, or mixtures thereof, and the like.

The presence of hueing dyes, for example, is used as a fabric shading dyes, which are useful adjuncts in fluid detergent compositions. Examples of suitable hueing dyes include, but are not limited to, blue and/or violet dyes having a hueing or shading effects. The fluid detergent compositions herein may contain from about 0.00003 w/w %-0.1 w/w %, typically from about 0.00008 w/w %-0.05 w/w %, suitably from about 0.0001 w/w %-0.04 w/w %, by weight of the fabric hueing dye.

The purpose of graying inhibitors is to keep dirt released from the fibers suspended in the bath, thus preventing the dirt from redepositing. Water-soluble colloids, usually organic in nature, are suitable for this, for example size, gelatin, salts of ethersulfonic acids of starch or cellulose, or salts of acid sulfuric acid esters of cellulose or starch. Water-soluble polyamides containing acid groups are also suitable for this purpose. Soluble starch preparations, and starch products other than those mentioned above, can also be used, e.g. degraded starch, aldehyde starches, etc. Polyvinylpyrrolidone is also usable. It is suitable, however, to use cellulose ethers such as carboxymethyl cellulose (Na salt), methyl cellulose, hydroxyalkyl cellulose, and mixed ethers such as methylhydroxyethyl cellulose, methylhydroxypropyl cellulose, methylcarboxymethyl cellulose, or mixtures thereof and the like.

The presence of optical brighteners, for example, is used to improve the apparent “whiteness” of clothes by absorbing invisible UV light and giving off a blue fluorescence. Examples include, but are not limited to, Tinopal CBS-X from BASF other, brightening agent (such as disodium distyrylbiphenyl disulfonate), opacifier (such as styrene/acrylates copolymer), or mixtures thereof and the like.

Optical brighteners may be added to the liquid washing and cleaning agents, as desired, in order to eliminate graying and yellowing of the treated textile fabrics. These substances are absorbed onto the fibers and cause a brightening and simulated bleaching effect by converting invisible ultraviolet radiation into visible longer-wave light; the ultraviolet light absorbed from sunlight is radiated as a weakly bluish fluorescence, combining with the yellow tint of the grayed or yellowed laundry to yield pure white. Examples of suitable compounds derive, include, but are not limited to, 4,4′-diamino-2,2′-stilbenedisulfonic acids (flavonic acids), 4,4′-distyrylbiphenylene, methylumbelliferones, cumarins, dihydroquinolinones, 1,3-diarylpyrazolines, naphthalic acid imides, benzoxazole, benzisoxazole, and benzimidazole systems, and the pyrene derivatives substituted with heterocycles, or mixtures thereof and the like. If desired, the optical brighteners are usually used in quantities between 0.05 w/w %-3 w/w %, based on the complete agent.

The presence of viscosity modifiers are used to help increase or decrease viscosity to desired level with the addition of propylene glycol, sodium xylene sulfonate, polymers, or mixtures thereof, and the like.

The presence of suds suppressors are used to control amount of sud such as substances including, but not limited to, the usage of soaps, silicates, silicones, or mixtures thereof, and the like. Suitably any substance used to control excessive foaming may be desirable.

Additionally, if an enzyme is present in the detergent composition, one or more enzyme stabilizing agents may be added to the detergent composition. Examples of enzyme stabilizers include, but are not limited to, thiophene-2 boronic acid, thiophene-3 boronic acid, acetamidophenyl boronic acid, benzofuran-2 boronic acid, naphtalene-1 boronic acid, naphtalene-2 boronic acid, 2-fomyl phenyl boronic acid (2-FPBA), 3-FBPA, 4-FPBA, 1-thianthrene boronic acid, 4-dibenzofuran boronic acid, 5-methylthiophene-2 boronic, acid, thionaphtrene boronic acid, furan-2 boronic acid, furan-3 boronic acid, 4,4 biphenyldiboronic acid, 6-hydroxy-2-naphtalene, 4-(methylthio)phenyl boronic acid, 4 (trimethylsilyl)phenyl boronic acid, 3-bromothiophene boronic acid, 4-methylthiophene boronic acid, 2-naphtyl boronic acid, 5-bromothiphene boronic acid, 5-chlorothiophene boronic acid, dimethylthiophene boronic acid, 2-bromophenyl boronic acid, 3-chlorophenyl boronic acid, 3-methoxy-2-thiophene, p-methyl-phenylethyl boronic acid, 2-thianthrene boronic acid, di-benzothiophene boronic acid, 4-carboxyphenyl boronic acid, 9-anthryl boronic acid, 3,5 dichlorophenyl boronic, acid, diphenyl boronic acidanhydride, o-chlorophenyl boronic acid, p-chlorophenyl boronic acid m-bromophenyl boronic acid, p-bromophenyl boronic acid, p-fluorophenyl boronic acid, p-tolyl boronic acid, o-tolyl boronic acid, octyl boronic acid, 1,3,5 trimethylphenyl boronic acid, 3-chloro-4-flourophenyl boronic acid, 3-am inophenyl boronic acid, 3,5-bis-(trifluoromethyl)phenyl boronic acid, 2,4 dichlorophenyl boronic acid, 4-methoxyphenyl boronic acid, or mixtures thereof and the like.

The presence of a pH adjusting agent is used to help maintain/control the pH of the detergent composition. Examples of pH adjusting agents include, but are not limited to the addition of citric acid, monoethanolamine or salts thereof; sodium carbonate, sodium sulfate, sodium hydroxide, or mixtures thereof and the like.

Examples of bleaching agents include, but are not limited to, sodium perborate tetrahydrate and sodium perborate monohydrate are of particular importance. Other usable bleaching agents are, for example, sodium percarbonate, peroxypyrophosphates, citrate perhydrates, and peracid salts or peracids that yield H2O2, such as perbenzoates, peroxyphthalates, diperazelaic acid, phthaloimino peracid, diperdodecanedioic acid, or mixtures thereof and the like.

For example, the peroxygen bleach component in the composition can be formulated with an activator (peracid precursor), include, but are not limited to, tetraacetyl ethylene diamine (TAED), benzoylcaprolactam (BzCL), 4-nitrobenzoylcaprolactam, benzoylvalerolactam (BZVL), 3-chlorobenzoylcaprolactam, benzoyloxybenzenesulphonate (BOBS), nonanoyloxybenzenesulphonate (NOBS), phenyl benzoate (PhBz), decanoyloxybenzenesulphonate (C10-OBS), octanoyloxybenzenesulphonate (C8-OBS), perhydrolyzable esters and mixtures thereof, alternatively benzoylcaprolactam and benzoylvalerolactam, 4-[N-(nonaoyl)amino hexanoyloxyl]-benzene sulfonate sodium salt (NACA-OBS) (See U.S. Pat. No. 5,523,434), dodecanoyloxy-benzenesulphonate (LOBS or C12-OBS), 10-undecenoyloxybenzenesulfonate (UDOBS or C11-OBS with unsaturation in the 10 position), and decanoyloxybenzoic acid (DOBA), or mixtures thereof, and the like. Non-limiting examples of suitable bleach activators, including quaternary substituted bleach activators, are described in U.S. Pat. No. 6,855,680.

For example, other bleach catalysts such as organic bleach catalysts and cationic bleach catalysts are suitable for the fluid detergent compositions of the disclosure. Organic bleach catalysts are often referred to as bleach boosters, depending on the desired application of the detergent composition. For example, the fluid detergent compositions herein may contain one or more organic bleach catalysts to improve low temperature bleaching.

Examples of suitable organic bleach catalysts include, but are not limited to, zwitterionic bleach catalysts, including aryliminium zwitterions. Suitable examples include 3-(3,4-dihydroisoquinolinium)propane sulfonate and 3,4-dihydro-2[2-(sulfooxy)decyl]-isoquinolimium, or mixtures thereof and the like.

Bleach activators can be incorporated into the washing and cleaning agents in order to achieve an improved bleaching effect when washing at temperatures of 60° C., and below. Examples of bleaching activators include, but are not limited to, compounds that under perhydrolysis conditions, yield aliphatic peroxycarboxylic acids having C1-C10 atoms, in particular C2-C4 atoms, and/or optionally substituted perbenzoic acid, can substances useful as bleaching activators. For example, substances that carry O- and/or N-acyl groups having the aforesaid number of carbon atoms, and/or optionally substituted benzoyl groups, are suitable. Multiply acylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylim ides, in particular N-nonanoyl succinimide (NOSI), acylated phenolsulfonates, in particular n-nonanoyl or isononanoyl oxybenzenesulfonate (n- and iso-NOBS), carboxylic acid anhydrides, phthalic acid anhydride, acylated polyvalent alcohols, in particular triacetin, ethylene glycol diacetate, 2,5-diacetoxy-2,5-dihydrofuran, or mixtures thereof and the like.

In addition to or instead of the conventional bleach activators, so-called bleach catalysts can also be incorporated into the liquid washing and cleaning agents. These substances are bleach-intensifying transition-metal salts or transition-metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru ammine complexes, mixtures thereof, and the like; are also applicable as bleach catalysts.

It may be desired to provide a detergent composition containing a bio-based product wherein the term “bio-based product” herein, refers to a substance made with a certain amount of renewable materials from a natural source. Such a composition may additionally be free of dyes, chlorine, phosphates, ethanolamine, optical brightener, or mixtures thereof, and the like.

The detergent composition, according to present disclosure, is useful for hygiene, or consumer/home care products such as dishwashing, laundry, dish hand-washing liquid and other household detergent-based compositions.

Additionally, in a further aspect for an end-user formulation, the detergent composition may be provided for consumer/home care or hygiene products containing (a) a composition of the present disclosure, and (b) water, an aqueous solvent, non-aqueous solvent and mixtures thereof.

In one aspect, an automatic dishwashing product containing the detergent composition according to the present disclosure may be combined with water, aqueous solvent, non-aqueous solvent or mixtures thereof; wherein such a composition is useful for dishwashing products, laundry products, dish hand-washing products, or other household detergent-based compositions.

If desired, the end-user formulation or automatic dishwashing product contains between 0.1 w/w %-85 w/w %, by weight of the concentrated detergent composition, based on the weight of the formulation.

Additionally, the end-user formulation or automatic dishwashing product contains between 0.1 w/w %-50 w/w %, by weight of the concentrate composition, based on the weight of the formulation.

In another aspect, the end-user formulation useful for hygiene or consumer/home care products contains a dishwashing liquid, laundry detergent, dish hand-washing liquid, and other household detergent-based compositions.

The following examples illustrate the disclosure without limitation. All parts and percentages are given by weight unless otherwise indicated.

Furthermore, certain embodiments of the present disclosure may be better understood according to the following examples, which are intended to be non-limiting and exemplary in nature. It will be understood that each of the elements described in the examples below, or two or more together may also find a useful application in other types of methods differing from the type described above.

The following examples are intended to be exemplary formulations for each of the end-user formulations, which may be prepared in accordance to the present disclosure.

### Example 1

TABLE 1
Liquid detergent composition

| | Use | | Use |
|---|---|---|---|
| | Level | | Level |
| Ingredient | (%) | | (%) |
| Aqua | Up to 100 | C₁₂₋₁₈ Fatty acid | 4.0 |
| Sodium C₁₀₋₁₃ Linear Alkyl | 14.0 | Solvents | 3.0 |
| Benzenesulfonate | | | |
| Polyglyceryl-10 laurate | 10.0 | Preservatives | 2.0 |
| Citric Acid MEA Salt | 10.0 | Whitening agents | 1.0 |
| C₁₂₋₁₅ alkyl 3-ethoxy | 6.0 | Enzymes | 2.0 |
| sulfate | | | |
| Propylene Glycol | 4.0 | Other Processing aids | 0.5-15 |

### Example 2

TABLE 2
Hand dish composition

| | Use | | Use |
|---|---|---|---|
| | Level | | Level |
| Ingredient | (%) | Ingredient | (%) |
| Aqua | Up to 100 | Polymers | 2.0 |
| C₁₂₋₁₅ alkyl 3-ethoxy | 25.0 | Other processing | 0.5-15 |
| sulfate | | aids | |
| Polyglyceryl-10 | 8.0 | Ethanol | 1.0 |
| Caprylate/Caprate | | | |
| Polypropylene Glycol | 8.0 | Perfumes | 1.0 |
| C₁₂₋₁₄ Alpha Olefin Sulfonate | 5.0 | Monoethanolamine | 3.0 |
| or C₁₂₋₁₄ Amine Oxide | | Borate | |

### Example 3

TABLE 3
Unit dose laundry detergent composition

| | Use | | Use |
|---|---|---|---|
| | Level | | Level |
| Ingredient | (%) | Ingredient | (%) |
| Aqua | Up to 100 | Polymers | 5.0 |
| MEA Dodecylbenzenesulfo- | 22.0 | Other processing | 0.5-15 |
| nate | | aids | |
| C₁₂₋₁₈ Fatty acid | 15.0 | Enzymes | 2.0 |
| Dipropylene Glycol | 10.0 | Whitening agents | 1.0 |
| C₁₂₋₁₅ alkyl 3-ethoxy sulfate | 8.0 | Builders or chelants | 3.0 |
| 1,2 Propane diol | 8.0 | preservatives | 2.0 |
| Polyglyceryl-10 | 8.0 | Polyglyceryl-10 | 6.0 |
| Caprylate/Caprate | | Oleate | |
| Citric Acid | 8.0 | Glycerin | 3.0 |

### Example 4

TABLE 4
Gel/Compacted laundry fluid

| | Use | | Use |
|---|---|---|---|
| | Level | | Level |
| Ingredient | (%) | Ingredient | (%) |
| Aqua | Up to 100 | builders or chelants | 2.0 |
| MEA Dodecylbenzenesulfo- | 37.0 | Enzymes | 3.0 |
| nate | | | |
| MEA-Laureth Sulfate | 14.0 | preservative | 2.0 |
| MEA-Palm Kernelate | 6.0 | other processing | 0.5-15 |
| | | aids | |
| Polyglyceryl-10 Laurate | 6.0 | Whitening agent | 3.0 |
| Polyglyceryl-10 Oleate | 3.0 | solvent | 10% |

### Example 5

TABLE 5
Liquid detergent for fabric care

| | Use | | Use |
|---|---|---|---|
| | Level | | Level |
| Ingredient | (%) | Ingredient | (%) |
| Aqua | Up to 100 | Builders or chelants | 3.0 |
| MEA Dodecylbenzenesulfo- | 20.0 | enzymes | 3.0 |
| nate | | | |
| Polyglyceryl-10 | 10.0 | Other processing | 0.5-15 |
| Caprylate/Caprate | | aids | |
| Citric Acid MEA Salt | 10.0 | preservatives | 2.0 |
| C₁₂₋₁₅ alkyl 3-ethoxy sulfate | 8.0 | Whitening agent | 1.0 |
| 1,2 Propane diol | 8.0 | perfume | 2.0 |
| Polyglyceryl-10 Oleate | 6.0 | solvents | 3.0 |
| C₁₂₋₁₈ Fatty acid | 6.0 | Monoethanolamine | 3.0 |
| | | Borate | |

### Example 6

TABLE 6
Fluid laundry detergent composition

| | Use | | Use |
|---|---|---|---|
| | Level | | Level |
| Ingredient | (%) | Ingredient | (%) |
| Aqua | Up to 100 | C₁₂₋₁₄ Alpha Olefin | 3.6 |
| | | Sulfonate or C₁₂₋₁₄ | |
| | | Amine Oxide | |
| Sodium C₁₀₋₁₃ Linear | 4.0 | preservatives | 2.0 |
| Alkylbenzenesulfonate | | | |
| C₁₂₋₁₄ alkyl | 4.0 | other processing aids | 0.5-15 |
| Polyethoxylate sulfate | | | |
| Polyglyceryl-10 Laurate | 4.0 | | |

### Example 7

TABLE 7
Diluted laundry detergent fluid

| | Use | | Use |
|---|---|---|---|
| | Level | | Level |
| Ingredient | (%) | Ingredient | (%) |
| Aqua | Up to 100 | preservatives | 2.0 |
| Sodium C₁₀₋₁₃ Linear | 4.5 | PEG/Polyvinyl Acetate | 0.8 |
| Alkylbenzenesulfonate | | Co-polymer | |
| Polyglyceryl-10 Laurate | 3.2 | other processing aids | 0.5-15 |
| Cocamide DEA | 1.0 | | |

For example, for a front-loading washing machine (˜50 L) a consumer would use ˜50 mL of product (concentrate) which will be diluted down during the wash cycle ×1000. Additionally, it is suggested that it would not use <1% Polyglyceryl esters as you would be below the critical micelle concentration (CMC). In order for effective detergency to be observed, the compositions mentioned above and provided in this present disclosure must therefore be above this value.

While the invention has been described above with references to specific embodiments thereof, it is apparent that many changes, modifications and variations can be made without departing from the invention concept disclosed herein. Accordingly, it is intended to embrace all such changes, modifications, and variations that fall within the spirit and broad scope of the appended claims.

What is claimed is:

1. A detergent composition comprising a surfactants and a carrier; wherein the surfactant comprises a polyglyceryl fatty acid ester or a mixture of polyglyceryl fatty acid esters.

2. The detergent composition according to claim 1, wherein the polyglyceryl fatty ester is derived from (a) a polyglycerol component built up from 2 to 18 molecules of glycerol, based on an average, and (b) a fatty acid selected from the group consisting of caprylic acid, capric acid, lauric acid, myristic acid, palmitic acid, stearic acid, arachidic acid, behenic acid, lignoceric acid, cerotic acid, oleic acid, decaoleic acid, ricinoleic acid or mixtures thereof.

3. The detergent composition according to claim 2, wherein the polyglyceryl fatty ester comprises polyglyceryl-10 decaoleate; polyglyceryl-3 monostearate; polyglyceryl-6 distearate, polyglyceryl-10 stearate; polyglyceryl-10 oleate; polyglyceryl-10 dipalmitate, polyglyceryl-10 caprylate/caprate; polyglyceryl-10 laurate, or mixtures thereof.

4. The detergent composition according claim 1, wherein the carrier comprises an aqueous solvent, a non-aqueous solvent or mixtures thereof.

5. The detergent composition, according to claim 4, wherein the aqueous solvent comprises water, aqueous alcohols, ammonia water, acid solutions, salt solutions, water-miscible organic solvents or mixtures thereof.

6. The detergent composition, according to claim 5, wherein the water miscible organic solvent comprises a univalent or polyvalent alcohols, alkanolamines, glycol ethers, or mixtures thereof.

7. The detergent composition, according to claim 1, further comprising at least one anionic surfactant.

8. The detergent composition, according to claim 7, wherein the anionic surfactant comprises a C₁₁-C₁₈ alkyl benzene sulfonates, C₁₀-C₂₀ branched-chain and random alkyl sulfates, C₁₀-C₁₈ alkyl ethoxy sulfates, mid-chain branched alkyl sulfates, mid-chain branched alkyl alkoxy sulfates, C₁₀-C₁₈ alkyl alkoxy carboxylates comprising 1-5 ethoxy units, modified alkylbenzene sulfonate, C₁₂-C₂₀ methyl ester sulfonate, C₁₀-C₁₈ alpha-olefin sulfonate, C₆-C₂₀ sulfosuccinates, fatty methyl ester sulphonates and/or alkyl ethyoxy sulphates (AES) and/or alkyl polyalkoxylated carboxylates (AEC), or mixtures of two or more thereof.

9. The detergent composition according to claim 7, wherein the anionic surfactant comprises sodium coco sulfate, ammonium coco sulfate, sodium lauryl glucosides hydroxypropyl sulfonate, ammonium lauryl glucosides hydroxypropyl sulfonate, sodium decyl glucosides hydroxypropyl sulfonate, ammonium decyl glucosides hydroxypropyl sulfonate or mixtures thereof.

10. The detergent composition, according claim 1, further comprising a builder, chelant, antioxidants or a mixture thereof.

11. The detergent composition, according claim 1, further comprising a polymer; wherein the polymer comprises a polycarboxylate, a polyacrilate (PAA), carboxymethyl cellulose, poly-ethylene-imine (PEI), peg-136 polyvinyl acetate, a polyethyleneimine ethoxylate, polyvinyl alcohol, polystyrene, polyacrylates copolymers, sodium polyacrylate, amphiphilic alkoxylated grease cleaning polymer, clay soil cleaning polymers, soil release polymers, soil suspending polymers, acrylic polymers or a mixture thereof.

12. The detergent composition according claim 1, further comprising an enzyme, wherein the enzyme comprises one or more of a proteases, amylases, cellobiases, cellulases, lipases, xylogucanases, pectate lyases, mannanases, bleaching enzymes, cutinases, lipolytically active enzymes, glycosyl hydrolases, enzymatic actives, or mixtures thereof.

13. The detergent composition, according claim 1, further comprising a whitening agent or perfume.

14. The detergent composition according claim 1, further comprising a preservative system, wherein the preservative system comprises benzoic acid, sodium benzoate, benzyl alcohol, sorbic acid or salts thereof, parabens, dehydroacetic acid, bronopol, triclosan, imidazolidinyl urea, PHMB, phenoxyethanol, DMDMH, ethylhexylglycerol, isothiazolones, chlorhexidine, diazolidinyl urea, chlorphenesin, sodium hydroxymethylglycinate, benzethonoium chloride, IPBC (iodopropynyl butylcarbamate), salicylic acid, organic acids, natural acids or a mixtures thereof.

15. The detergent composition according to claim 1, further comprising an emollient, wherein the emollient comprises a wax, oil, or mixtures thereof.

16. The detergent composition according to claim 15, wherein the emollient is an oil comprising an ester oil, an ether oil, or mixtures thereof.

17. The detergent composition comprising
(a) 0.1 w/w %-35 w/w % of a polyglyceryl fatty acid ester or a mixture of polyglyceryl fatty acid esters;
(b) 1 w/w %-70 w/w % of an anionic surfactant, or a mixture of anionic surfactants;
(c) 1 w/w %-10 w/w % or a builder, chelant, antioxidant or a mixture thereof;
(d) 0 w/w %-10 w/w % of a polymer;
(e) 0 w/w %-5 w/w % of an enzyme;
(f) 0 w/w %-5 w/w % of a whitening agents or perfumes or a mixture thereof; and
(g) 0.5 w/w %-15 w/w % of a solvent; each component present in an amount based on the total weight of the detergent composition.

18. The detergent composition, according to claim 17, comprising
(a) 0.1 w/w %-20 w/w % of a surfactant comprising a polyglyceryl fatty acid ester or a mixture of polyglyceryl fatty acid esters;
(b) 1 w/w %-40 w/w % of an anionic surfactant, or a mixture of anionic surfactants;
(c) 2 w/w %-5 w/w % of a builder, chelant, antioxidant or a mixture thereof;
(d) 1 w/w %-5 w/w % of a polymer;
(e) 0.1 w/w %-3 w/w % of an enzyme;
(f) 0.1 w/w %-5 w/w % of a whitening agents or perfumes or a mixture thereof; and
(g) 0.5 w/w %-10 w/w % of a solvent; each component present in an amount based on the total weight of the detergent composition.

19. The detergent composition according to claim 1, wherein the pH of the composition is between 3 and 12.

20. The detergent composition, according to claim 1, wherein the composition is in the form of a liquid, gel, suspension, capsule, or powder.

21. The detergent composition, according to claim 1, wherein the composition is enclosed within a water soluble pouch material.

22. The detergent composition according to claim 1, further comprising at least one additional ingredients selected from a bleaching agent, bleaching activators, bleaching catalysts, surfactant, enzyme stabilizers, optical brighteners, gray inhibitors, hueing dyes, particulate material, odor controlling agents, hydrotropes, suds suppressors, fabric care benefit agents, pH adjusting agents, dye transfer inhibiting agents, non-fabric substantive dyes, colorants, washing aids, antiredeposition agents, viscosity modifier, processing aid, amphiphilic alkoxylated grease cleaning polymer, clay soil cleaning polymers, soil release polymers, soil suspending polymers, thickening agents, cleaning aid/agent, detergent additives or mixtures thereof.

23. The detergent composition, according to claim 1, in the form of a dishwashing liquid, laundry detergent, hand washing liquid, or other household detergent-based compositions.
